(19) United States
(12) Patent Application Publication
(10) Pub. No.: US 2025/0038291 A1
(43) Pub. Date: Jan. 30, 2025

(54) THERMAL RUNAWAY PROPAGATION MITIGATION SYSTEM AND METHOD

(71) Applicant: GM GLOBAL TECHNOLOGY OPERATIONS LLC, Detroit, MI (US)

(72) Inventors: Vincent E. Herrman, Clawson, MI (US); Wei Zeng, Oakland Township, MI (US); Anil Yadav, Troy, MI (US); Scott W. Lananna, Detroit, MI (US)

(73) Assignee: GM GLOBAL TECHNOLOGY OPERATIONS LLC, Detroit, MI (US)

(21) Appl. No.: 18/360,261

(22) Filed: Jul. 27, 2023

(51) Int. Cl. H01M 10/613; H01M 10/625; H01M 10/653; H01M 50/204; H01M 50/30

(52) U.S. Cl. CPC H01M 10/613; H01M 10/625; H01M 10/653; H01M 50/204; H01M 50/30; H01M 2220/20

(57) ABSTRACT

A rechargeable energy storage system (RESS) for a vehicle having thermal runaway propagation mitigation includes at least two battery modules disposed within the RESS. Each battery module includes a plurality of battery cell groups, and a thermal barrier disposed at an end portion of each battery module. Each thermal barrier extends along a width of the end portion of each battery module, and includes a plurality of openings having at least one opening aligned with each of the plurality of battery cell groups of each battery module, and a relief portion adjacent to each of the plurality of openings. The relief portions prevent hot gas and/or particles from venting through an opening adjacent to the relief portion when in a closed position, and allows the hot gas and/or particles to vent through the opening adjacent to the relief portion when in an open position.

### INTRODUCTION

The concepts described herein relate generally to rechargeable energy storage systems (RESS) that include at least one battery module configured to mitigate thermal runaway propagation within the RESS.

Each battery module within the RESS may include a plurality of battery cell groups or packs, with each battery cell group including a plurality of battery cells, for example, lithium-ion battery cells.

A lithium-ion battery cell is an electrochemical device that operates by passing lithium ions between a negative electrode (or anode) and a positive electrode (or cathode). Electrochemical battery cells including, but not limited to, prismatic battery cells and cylindrical battery cells having metallic enclosures or “cans” may include heat dissipation pathways for effective and consistent heat dissipation over a life of the battery cell.

Generally, in most lithium-ion battery cells, the negative and positive electrodes are situated on opposite sides of a porous polymer separator to form an electrode stack. The electrode stack may be part of an electrode assembly, and may include a protective wrap. The electrode stack or assembly is disposed within a battery enclosure, for example, but not limited to a pouch, and soaked or “wetted” with an electrolyte solution suitable for conducting lithium ions.

DC power sources, such as lithium-ion batteries, may be employed to store and release electric power that may be employed by an electric circuit or an electric machine to perform work, such as for communications, display, or propulsion. Heat may be generated by the processes of converting electric power to chemical potential energy, i.e., battery charging, and converting chemical potential energy to electric power, i.e., battery discharging.

Accordingly, each battery module and battery group or pack may generate an even greater amount of heat than an individual battery cell. Exposure of an individual battery cell to elevated temperatures over prolonged periods of time may cause the individual battery cell to experience a thermal runaway event, i.e., an uncontrolled increase in temperature within the individual battery cell, which may lead to propagation of the thermal runaway to adjacent battery cells within the battery group, and subsequently to adjacent battery modules within a RESS.

During a thermal runaway event, the generation of heat within an individual battery cell or RESS exceeds the dissipation of heat, thus leading to a further increase in temperature.

Current cooling or heat-dissipation strategies for battery modules or battery pack may include, for example, but not limited to, cooling plates disposed within the battery module or battery pack, for example but not limited to, between the individual battery cells, between the battery packs within the battery module, and/or between the battery packs and the battery module. These current cooling or heat-dissipation strategies are helpful to regulate a thermal load within the individual battery cells, battery packs, and/or battery modules, however, once a thermal runaway event has occurred, these current strategies may not be sufficient to mitigate propagation of thermal runaway between adjacent modules within a RESS.

### SUMMARY

In view of the above discussion, it is useful to develop a rechargeable energy storage system (RESS) that includes a battery module having a thermal barrier that is operable to provide ventilation for a battery module experiencing thermal runaway, i.e., a battery module including a propagated battery cell, and protect adjacent battery modules not experiencing thermal runaway, i.e., adjacent battery modules not including propagated cells, from propagation of the thermal runaway. Thermal runaway propagation mitigation may be provided herein by including a thermal barrier disposed at an end portion of a battery module, external to a plurality of battery cell groups within the battery module.

The thermal barrier may be more effective than current strategies by relieving pressure from a propagated battery cell within a battery module, and directing hot gases and/or particulate from the battery module including the propagated battery cell, to an outside of a RESS, away from other battery modules within the RESS that may not include propagated battery cells.

A rechargeable energy storage system (RESS) having thermal runaway propagation mitigation and a method of thermal runaway propagation mitigation are also disclosed.

The RESS having thermal runaway propagation mitigation may include at least two battery modules disposed within the RESS. Each of the at least two battery modules may include a plurality of battery cell groups, and a thermal barrier, which may be disposed at an end portion of each of the at least two battery modules.

The thermal barrier may extend along a width of the end portion of each of the at least two battery modules, and may include a plurality of openings including at least one opening aligned with each of the plurality of battery cell groups.

A relief portion may be adjacent to each of the plurality of openings, and may prevent hot gas and/or particles from venting through the opening adjacent to the relief portion when the relief portion is in a closed position, and may allow the hot gas and/or particles to vent through the opening adjacent to the relief portion when the relief portion is in an open position.

The plurality of battery cell groups included in one of the at least two battery modules may include at least one propagated battery cell group, and the plurality of battery cell groups included in another of the at least two battery modules may include no propagated battery cell groups.

The thermal barrier may direct hot gas and/or particles from the one of the at least two battery modules including the at least one propagated battery cell group away from the other of the at least two battery modules including no propagated battery cell groups and/or a high voltage connection.

Hot gas from the at least one propagated battery cell group may move the relief portion of the thermal barrier, adjacent to the opening aligned with the at least one propagated battery cell group, to the open position. The hot gas and/or particles from the at least one propagated battery cell group may vent through the opening adjacent to the relief portion of the thermal barrier, via gas pathways in the RESS that may vent the hot gas and/or particles to an outside of the RESS.

According to one aspect of the present disclosure, the plurality of battery cell groups included in one of the at least two battery modules may include at least one battery cell group having at least one propagated battery cell, and at least one battery cell group having no propagated battery cells. The relief portion of the thermal barrier, adjacent to the opening aligned with the at least one battery cell group, including the at least one propagated battery cell may be in an open position, while the relief portion of the thermal barrier, adjacent to the opening aligned with the at least one battery group having no propagated cells, may be in a closed position.

The thermal barrier may prevent a temperature of at least one of the at least two battery modules from exceeding a thermal runaway propagation threshold temperature.

The relief portion of the thermal barrier may include a one-way valve, and/or a break-away portion.

The one-way valve may prevent the hot gas and/or particles from venting through the one-way valve when the one-way valve is in a closed position, and the one-way valve may allow the hot gas and/or particles to vent through the one-way valve when the one-way valve is in the open position.

The rechargeable energy storage system (RESS) may include a binder clip attached to each battery cell group of the plurality of battery cell groups included in each of the at least two battery modules. Each binder clip may extend along a length of each battery cell group and may direct the hot gas and/or particles toward the thermal barrier at the end of each of the at least two battery modules.

The rechargeable energy storage system (RESS) may include a seal disposed between adjacent battery cell groups within the plurality of battery cell groups included in each of the at least two battery modules. The seal may prevent the hot gas and/or particles from flowing from a propagated cell group to a non-propagated cell group within each of the at least two battery modules.

According to another aspect of the present disclosure, a rechargeable energy storage system (RESS) having thermal runaway propagation mitigation may include a plurality of battery modules disposed within the RESS. Each of the plurality of battery modules may include a plurality of battery cell groups.

A thermal barrier may be disposed at an end portion of each of the plurality of battery modules and may extend along a width of the end portion of each of the plurality of battery modules.

Each thermal barrier may include a plurality of openings including at least one opening aligned with each of the plurality of battery cell groups included in each of the plurality of battery modules.

A relief portion may be adjacent to each of the plurality of openings. The relief portion may prevent hot gas and/or particles from venting through the opening adjacent to the relief portion when the relief portion is in a closed position, and may allow hot gas and/or particles to vent through the opening adjacent to the relief portion when the relief portion is in an open position.

The thermal barriers disposed at the end portions of each of the plurality of battery modules may form a cross-car thermal barrier system.

Each of the plurality of battery modules may be adjacent to another of the plurality of battery modules in a cross-car configuration.

The plurality of battery modules may include a first battery module having a first plurality of battery cell groups, and a second battery module having a second plurality of battery cell groups.

The first plurality of battery cell groups may include at least one propagated battery cell. Hot gas and/or particles from the at least one propagated battery cell included in the first plurality of battery cell groups may vent through the relief portion of the thermal barrier adjacent to the opening in the thermal barrier that is aligned with the first plurality of battery cell groups, via a first gas pathway that vents the hot gas and/or particles, from the at least one propagated battery cell included in the first plurality of battery cell groups, to an outside of the RESS.

The second plurality of battery cell groups may include at least one propagated battery cell. Hot gas and/or particles from the at least one propagated battery cell included in the second plurality of battery cell groups may vent through the relief portion of the thermal barrier adjacent to the opening in the thermal barrier that is aligned with the second plurality of battery cell groups, via a second gas pathway that vents the hot gas and/or particles, from the at least one propagated battery cell included in the second plurality of battery cell groups, to the outside of the RESS.

The first gas pathway and the second gas pathway are unaligned with one another.

According to another aspect of the present disclosure, a method of thermal runaway propagation mitigation within a rechargeable energy storage system (RESS) of a vehicle may include: installing the rechargeable energy storage system in the vehicle, the rechargeable energy storage system including at least two battery modules, each having a plurality of battery cell groups, wherein the at least two battery modules each includes a thermal barrier disposed at an end portion of each of the at least two battery modules, each thermal barrier extending along a width of the end portion of each of the at least two battery modules; generating power for the vehicle, via the rechargeable energy storage system; and directing, via the thermal barrier, hot gas and/or particles from one of the at least two battery modules including a propagated battery cell group away from another of the at least two battery modules including no propagated battery cell groups and/or a high-voltage connection.

The thermal barrier may include a plurality of openings including at least one opening aligned with each of the plurality of battery cell groups, and a relief portion adjacent to each of the plurality of openings.

The at least two battery modules may include a first battery module having a first propagated battery cell group, and a second battery module having a second propagated cell group.

The method of thermal runaway propagation mitigation may include: venting hot gas and/or particles from the first battery module having the first propagated cell group to an outside of the rechargeable energy storage system via a first gas pathway; and venting hot gas and/or particles from the battery module having the second propagated cell group to the outside of the rechargeable energy storage system via a second gas pathway.

The first gas pathway and the second gas pathway may be unaligned with one another.

Directing the hot gas and/or particles from one of the at least two battery modules including a propagated battery cell group may include: moving the relief portion of the thermal barrier adjacent to the opening in the thermal barrier aligned with the propagated battery cell group, to an open position, allowing the hot gas and/or particles to vent through the relief portion of the thermal barrier; and venting the hot gas and/or particles from the propagated battery cell group through the relief portion of the thermal barrier adjacent to the opening in the thermal barrier aligned with the propagated battery cell group.

The relief portion of the thermal barrier may be moved to the open position by the hot gas from the propagated battery cell group.

Hot gas and/or particles from the propagated battery cell group may vent through the relief portion of the thermal barrier via gas pathways. The hot gas and/or particles may be vented to an outside of the RESS.

When the relief portion of the thermal barrier adjacent to the opening in the thermal barrier aligned with the propagated battery cell group is moved to the open position, the relief portion of the thermal barrier adjacent to the opening in the thermal barrier aligned with the non-propagated batter cell group may remain in a closed position.

Venting the hot gas and/or particles from the propagated battery cell group may prevent a temperature of the non-propagated battery cell group from exceeding a thermal runaway propagation threshold temperature.

Therefore, by including a thermal barrier disposed at an end portion of each battery module within a rechargeable energy storage system (RESS), thermal runaway propagation mitigation may be provided, which may protect battery modules that are not experiencing thermal runaway, but which are adjacent to a battery module experiencing thermal runaway, from propagation of the thermal runaway by venting hot gas and/or particles from the battery module experiencing thermal runaway, and directing the hot gas and/or particles from the battery module experiencing thermal runaway, to an outside of the RESS.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a schematic illustration of a vehicle including rechargeable energy storage system (RESS) having thermal runaway propagation.

FIG. 2A is a schematic illustration of a top view of a RESS including a plurality of battery modules, constructed in accordance with the present disclosure.

FIG. 2B is a schematic illustration of the two battery modules adjacent cross-car from one another, encircled at A in FIG. 1, constructed in accordance with the present disclosure.

FIG. 3 is an exploded schematic illustration of a single battery module, constructed in accordance with the present disclosure.

FIG. 4A is a schematic illustration of a thermal barrier, encircled at B in FIG. 3, constructed in accordance with the present disclosure, including relief portions in a closed position.

FIG. 4B is a schematic illustration of a thermal barrier, encircled at B in FIG. 3, constructed in accordance with the present disclosure, including openings adjacent to the relief portions illustrated in FIG. 4A.

FIG. 4C is a schematic illustration of a thermal barrier, encircled at B in FIG. 3, constructed in accordance with the present disclosure, including a relief portion in an open position.

FIG. 5 is a schematic illustration of a RESS, constructed in accordance with the present disclosure, including gas pathways and vents.

FIG. 6A is a schematic illustration of a single battery module without a top cover, constructed in accordance with the present disclosure, including binder clips.

FIG. 6B is a schematic illustration of a section of the single battery module, indicated in FIG. 6A, constructed in accordance with the present disclosure, including bulb seals.

FIG. 7 is a flow chart illustrating a method of thermal runaway propagation mitigation in accordance with the present disclosure.

The appended drawings are not necessarily to scale, and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible of embodiment in many different forms.

Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including.” “containing,” “comprising.” “having.” and the like shall mean “including without limitation.” Moreover, words of approximation such as “about,” “almost.” “substantially.” “generally.” “approximately,” etc., may be used herein in the sense of “at, near, or nearly at,” or “within 0-5% of,” or “within acceptable manufacturing tolerances,” or logical combinations thereof.

Referring now to the drawings, wherein like numerals indicate like parts in several views, a rechargeable energy storage system (RESS) for a vehicle having thermal runaway propagation mitigation, including battery modules having a thermal barrier disposed at end portion of each battery module, and method of thermal runaway mitigation, are shown and described herein.

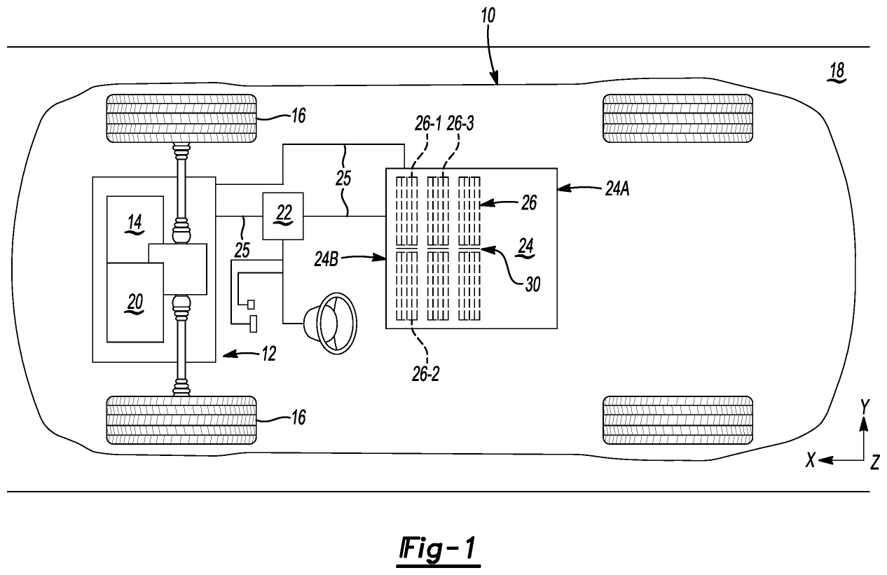

As illustrated in FIG. 1, a vehicle 10 includes a powertrain 12. The vehicle 10 may include, but is not limited to, a commercial vehicle, an industrial vehicle, a passenger vehicle, an aircraft, a watercraft, a train or the like. It is also contemplated that the vehicle 10 may include a mobile platform, such as an airplane, an all-terrain vehicle (ATV), a boat, a personal movement apparatus, a robot and the like to accomplish the purposes of this disclosure.

The powertrain 12 includes a power-source 14 configured to generate a power-source torque T (not shown) for propulsion of the vehicle 10 via driven wheels 16 relative to a road surface 18. The power-source 14 is depicted as an electric motor-generator.

As further illustrated in FIG. 1, the powertrain 12 may also include an additional power-source 20, such as an internal combustion engine. The power-sources 14 and 20 may act in concert to power the vehicle 10. The vehicle 10 additionally includes a programmable electronic controller 22 and a rechargeable energy storage system (RESS) 24 configured to generate and store electrical energy through heat-producing electro-chemical reactions for supplying the electrical energy to the power-sources 14 and 20. The electronic controller 22 may be programmed to control the powertrain 12 and the RESS 24 to generate a predetermined amount of power-source torque T, and various other vehicle systems.

The electronic controller 22 may include a central processing unit (CPU) that regulates various functions on the vehicle 10, or be configured as a powertrain control module (PCM) configured to control the powertrain 12.

In either of the above configurations, the electronic controller 22 includes a processor and tangible, non-transitory memory, which includes instructions for operation of the powertrain 12 and the RESS 24 programmed therein. The memory may be an appropriate recordable medium that participates in providing computer-readable data or process instructions. Such a recordable medium may take many forms, including, but not limited to, non-volatile media and volatile media.

Non-volatile media for the electronic controller 22 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection.

Memory of the electronic controller 22 may also include a flexible disk, hard disk, magnetic tape, another magnetic medium, a CD-ROM, DVD, another optical medium, etc. The electronic controller 22 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 22 or accessible thereby may be stored in the memory and automatically executed to provide the required functionality of the powertrain 12 and the RESS 24.

The RESS 24 having a front end 24A and a rear end 24B, may be connected to the power-sources 14 and 20, the electronic controller 22, as well as other vehicle systems via a high-voltage bus 25.

Operation of the powertrain 12 and the RESS 24 is generally regulated by the electronic controller 22.

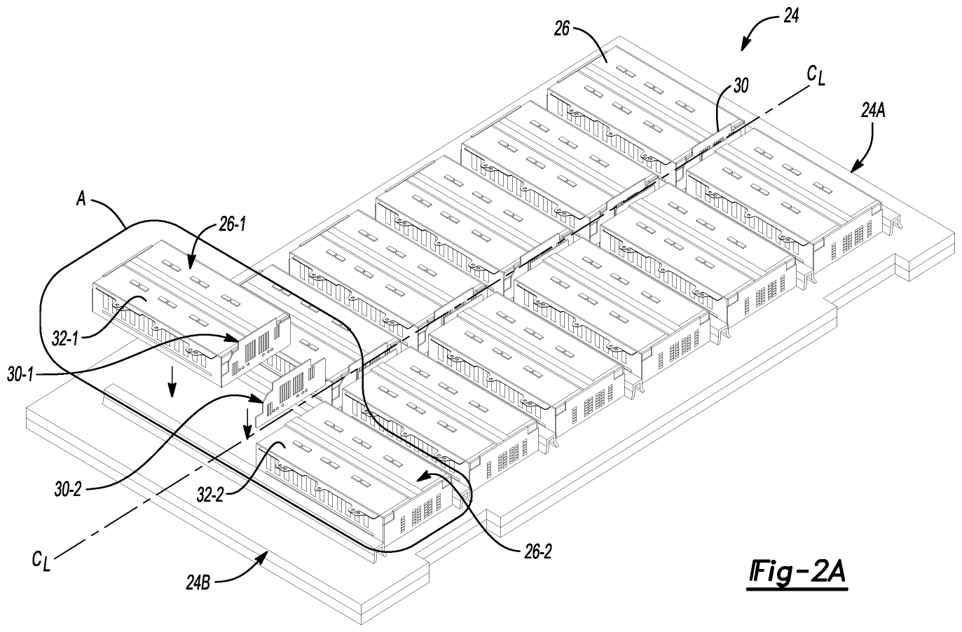

As shown in FIGS. 1 and 2A, according to the present disclosure, an RESS 24 includes a plurality of battery modules 26, such as a first battery module 26-1, and a second battery module 26-2, adjacent to the first battery module 26-1.

A plurality of thermal barriers 30 are illustrated generally between the plurality of battery modules 26, adjacent a centerline CL of the RESS 24.

While two battery modules 26-1, 26-2 are shown, it should also be appreciated that the RESS 24 may include a greater number of such battery modules, each such battery module including a thermal barrier corresponding to a specific battery module included therein. It should also be appreciated that, while the two battery modules 26-1, 26-2 are shown adjacent to one another, and disposed near a rear end 24B of the RESS 24, the two battery modules 26-1, 26-2, could correspond to any two battery modules disposed within the RESS 24. For simplicity, however, the present disclosure will focus on describing an RESS 24 specifically having two battery modules 26-1, 26-2, adjacent to one another, and two corresponding thermal barriers 30-1.30-2.

As illustrated in FIG. 2A, an RESS 24 having a front end 24A and a rear end 24B, includes a plurality of battery modules 26, which includes the first battery module 26-1, and the second battery module 26-2. Each of the battery modules 26-1, 26-2 includes a thermal barrier 30-1, 30-2.

For example, as illustrated in FIG. 2B, a first battery module 26-1 includes a thermal barrier 30-1, disposed at end portion 32-1 of the first battery module 26-1. A second battery module 26-2 includes a thermal barrier 30-2 disposed at an end portion 32-2 of the second battery module 26-2.

An external surface 31-1 of the thermal barrier 30-1 is adjacent to an external surface 31-2 of thermal barrier 30-2. Each thermal barriers 30-1, 30-2 includes a plurality of openings 50-1, 50-2, a plurality of relief portions 54-1, 54-2 adjacent to the plurality of openings, and a plurality of locating features 52-1, 52-2.

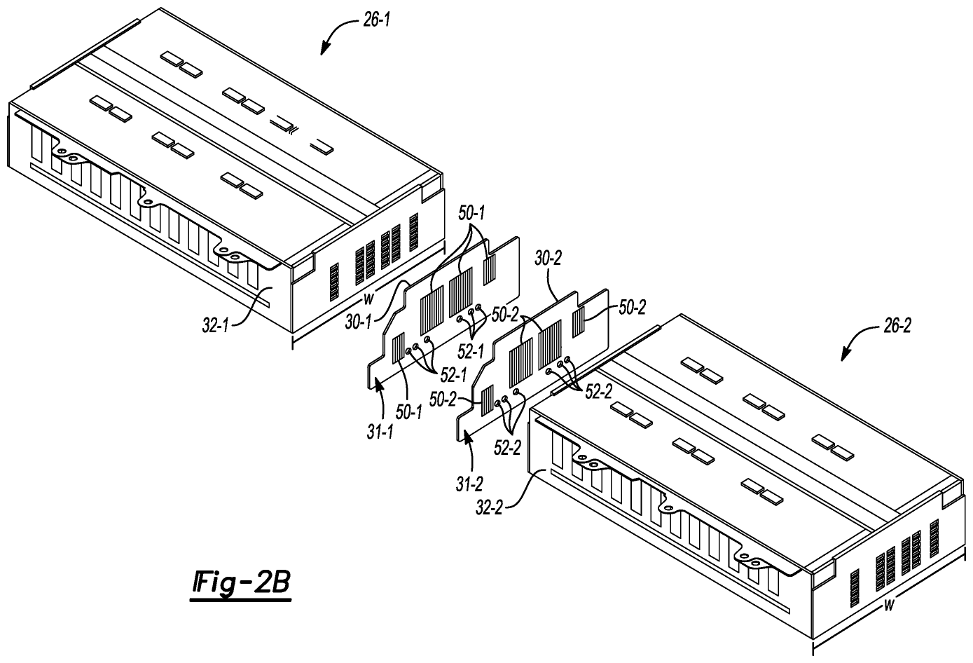

An exploded view of a first battery module 26-1 is illustrated in FIG. 3. The first battery module 26-1 includes side covers 34A-1 and 34B-1, a top cover 36-1, a bottom cover 38-1, and an end cover 40-1. The side covers 34A-1, 34B-1, the top cover 36-1, the bottom cover 38-1, and the end cover 40-1 may be constructed of, for example but not limited to, stamped steel. The bottom cover 38-1 may include a cooling feature 42-1, for example but not limited to, a cooling plate.

The first plurality of battery cell groups 28-1 is disposed within the first battery module 26-1. Each battery cell group included in the first plurality battery cell groups 28-1 is adjacent to another battery cell group within the first plurality of battery cell groups 28-1.

Each battery cell group included in the first plurality of battery cell groups 28-1 includes a first plurality of battery cells (not shown) internal to each battery cell group of the plurality of battery cell groups 28-1. Each battery cell (not shown) within the first plurality of battery cells (not shown) is adjacent to another battery cell within the first plurality of battery cells (not shown) internal to each battery cell group of the plurality of battery cell groups 28-1.

High voltage connectors 66, for example but not limited to, current collectors, are disposed at the end 46A of each of the plurality of battery cell groups 28-1.

Interconnect boards (ICBs) 44A-1, 44B-1 are disposed respectively at each end portion 46A-1 and 46B-1 of the first battery module 26-1.

A thermal barrier 30A-1 is disposed at the end portion 44A-1 of the first battery module 26-1.

An optional cover 48-1 may be disposed between the interconnect board 42A-1 and the thermal barrier 30-1.

Referring to FIGS. 2A, 2B, and 3, a rechargeable energy storage system (RESS) 24 includes first and second battery modules 26-1, 26-2 disposed within the RESS 24. The first battery module 26-1 includes a plurality of battery cell groups 28-1, and a thermal barrier 30-1, which is disposed at an end portion 32-1 of the first battery module 26-1. The second battery module 26-2 includes a plurality of battery cell groups 28-2 and a thermal barrier 30-2, which is disposed at an end portion 32-2 of second battery module 26-2.

Thermal barriers 30-1, 30-2 each extend along a width W of respective end portion 32-1, 32-2 of battery modules 26-1, 26-2. The thermal barrier 30-1 includes a plurality of openings 50-1 including at least one opening aligned with each of the plurality of battery cell groups 28-1. The thermal barrier 30-2 includes a plurality of openings 50-2 including at least one opening aligned with each of the plurality of battery cell groups 28-2.

A plurality of relief portions 54-1 are disposed adjacent to the plurality of openings 50-1, with each of the plurality of relief portions 54-1 being respectively adjacent to one of the plurality of openings 50-1 aligned with one of the plurality of battery groups 28-1 within the first battery module 26-1, within the RESS 24-1. A plurality of relief portions 54-2 are disposed adjacent to the plurality of openings 50-2, with each of the plurality of relief portions 54-1 being respectively adjacent to one of the plurality of openings 50-2 aligned with one of the plurality of battery groups 28-2 within the second battery module 26-2, within the RESS 24.

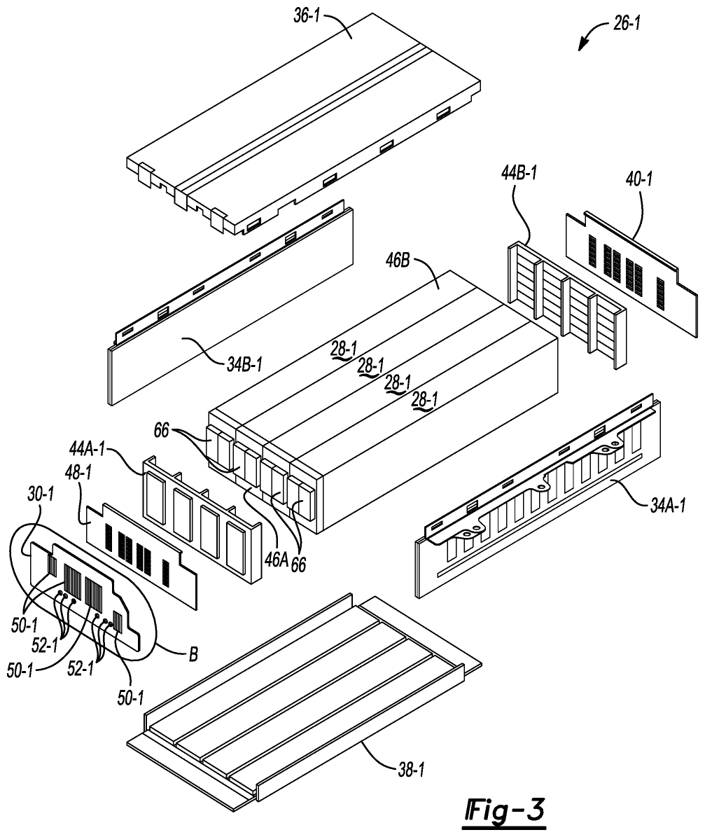

As illustrated in FIGS. 4A, 4B, and 4C, a thermal barrier 30-1 includes a plurality of relief portions 54-1 (FIG. 4A) adjacent to a plurality of openings 50-1 (FIG. 4B). Each of the plurality of relief portions 54-1 is moveable from a closed position P₁ (FIG. 4A), which prevents hot gas and/or particles from venting through the opening 50-1 adjacent to the respective relief portion 54-1, to an open position P2 (FIG. 4C), which allows the hot gas and/or particles to vent through the respective opening 50-1 adjacent to the respective relief portion 54-1 to an outside of the RESS 24-1.

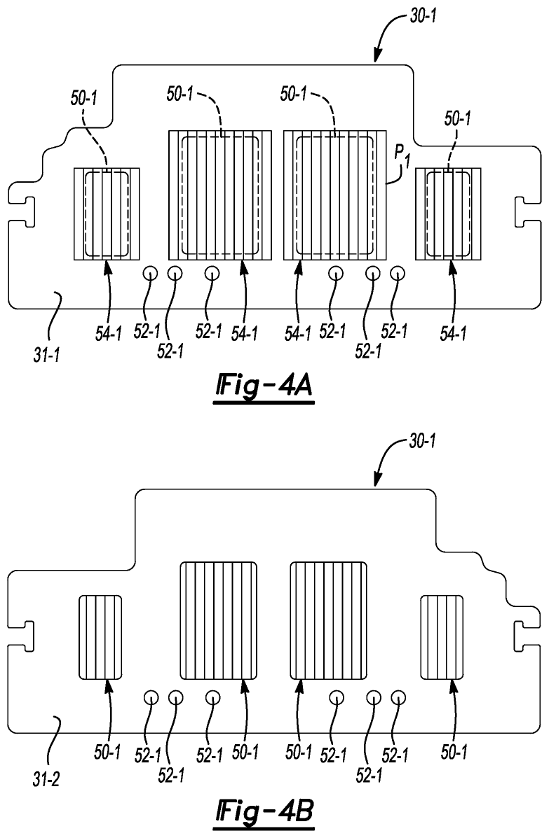

During a thermal runaway event within the first battery module 26-1, hot gases and/or particulate from the battery cell group 28-1 experiencing the thermal runaway event flow toward the opening 50-1 in the thermal barrier 30-1 aligned with the battery group 28-1 experiencing the thermal runaway event. This creates pressure against the relief portion 54-1 of the thermal barrier 30-1, adjacent to the opening 50-1, and moves the relief portion 54-1 from a closed position P₁ to an open position P2, allowing the hot gases and/or particles to vent through the opening 50-1, and be directed along gas pathways 58 internal to the RESS 24 to an outside of the RESS 24 through a plurality of vents 56 in the RESS 24 (FIG. 5).

In the illustrated example, each of the plurality of relief portions 54-1, 54-2 includes, for example but not limited to, a louver tape, which may include, for example but not limited to, a mica louver tape. The louver tape may be attached to the thermal barrier 30-1 via an adhesive liner (not shown). As such, during the thermal runaway event within the first battery module 26-1, the pressure against the louver tape causes the louver tape to split or otherwise release from the thermal barrier 30-1 to allow the hot gases and/or particles to vent through the opening 50-1.

While the thermal barrier 30-1 is illustrated including a plurality of relief portions 54-1, 54-2 including louver tape that releases from the thermal barrier 30-1 to allow the hot gases and/or particles to vent from the first battery module 26-1 during a thermal runaway event, it should be appreciated that the thermal barrier 30-1 may include relief portions, for example but not limited to one-way valves, burst valves, and/or other mechanical features that mechanically breakaway and/or move to allow the hot gases and/or particles to vent from the battery module experiencing a thermal runaway event.

Referring back to FIGS. 1 and 2A, first and second battery modules 26-1 and 26-2, are disposed adjacent to one another within the RESS 24 and it should be appreciated that the second battery module 26-2, includes like components corresponding to those described above with respect to the first battery module 26-1.

As illustrated in FIG. 5, a RESS 24 includes a plurality of battery modules 26 including a first battery module 26-1 having a first thermal barrier 30-1, and second battery module 26-2 having a second thermal barrier 30-2, adjacent to one another within the RESS 24. A plurality of vents 56 are disposed within the RESS 24 to allow hot gases and/or particles to vent to an outside of the RESS 24.

Thermal barriers 30-1 and 30-2 each include a plurality of openings 50-1 and 50-2, and a plurality of relief portions 54-1, 54-2. Each of the relief portions 54-1, 54-2 is adjacent to one of the plurality of openings 50-1, 50-2, each of which is aligned with one of a plurality of battery groups 28-1 and 28-2 within each battery module 26-1 and 26-2.

During a thermal runaway event in either of the first battery module 26-1 or the second battery module 26-2, the thermal barrier 30-1 or 30-2 of the battery module experiencing the thermal runaway event directs hot gas and/or particles from the module experiencing the thermal runaway event away from the module not experiencing the thermal runaway event, and/or a high voltage connection 66 (FIG. 3), for example but not limited to current collectors.

The thermal runaway event generates hot gas and/or particles, within the battery module 26-1 or 26-2 experiencing the thermal runaway event, sufficient to move the relief portion 54-1 or 54-2 of the thermal barrier 30-1 or 30-2, corresponding to the battery cell group 28-1 or 28-2 within the battery module 26-1 or 26-1 experiencing the thermal runaway event, from a closed position P₁ to an open position P2 allowing the hot gas and/or particles to vent to an outside of the RESS 24 through a plurality of vents 56 disposed in the RESS 24.

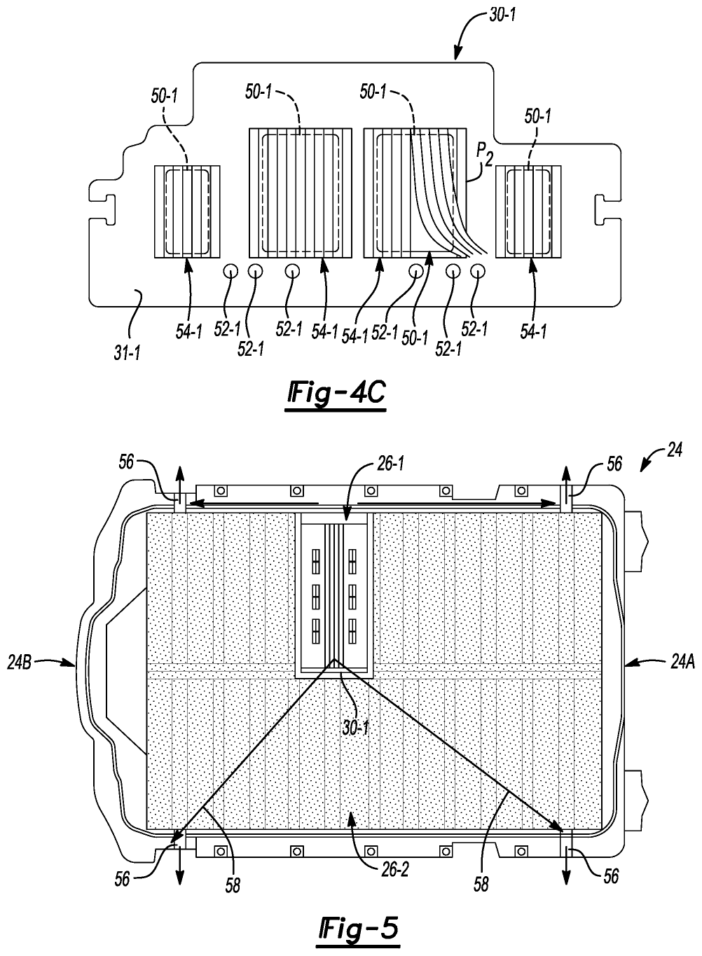

For example, when the first battery module 26-1 experiences a thermal runaway event, i.e., the first module 26-1 includes at least one propagated battery cell group, hot gas and/or particles are generated within the first battery module 26-1. The hot gas and/or particles may be directed by binder clips 60 (FIG. 6A) toward the thermal barrier 30-1 disposed at the end portion 32-1 of the battery module 26-1.

Hot gas from the at least one propagated battery cell group moves the relief portion 54-1 of the thermal barrier 30-1, adjacent to the opening 50-1 aligned with the at least one propagated battery cell group, to the open position P2. The hot gas and/or particles from the at least one propagated battery cell group vents through the opening 50-1 adjacent to the relief portion 54-1 of the thermal barrier 30-1, via, for example but not limited to, gas pathways 58 that vent the hot gas and/or particles to an outside of the RESS 24.

According to one aspect of the present disclosure, the plurality of battery cell groups 28-1 include a first battery cell group 28-1A having at least one propagated battery cell, and a second battery cell group 28-1B including a second battery cell group 28-1B having no propagated battery cells. The relief portion 54-1 of the thermal barrier 30-1, adjacent to the opening 50-1A aligned with the first battery cell group 28-1A, is in an open position P2, while the relief portion 54-1B of the thermal barrier 30-1, adjacent to the opening 50-1B aligned with the second battery cell group 28-1B, is in a closed position P₁.

The thermal barrier 30-1, 30-2 may prevent a temperature T of at least one of the at least two battery modules 26-1, 26-2 from exceeding a thermal runaway propagation threshold temperature Tₘₐₓ.

The relief portion 54-1, 54-2 of the thermal barrier 30-1, 30-2 may include a one-way valve, and/or a break-away portion.

The one-way valve may prevent the hot gas and/or particles from venting through the one-way valve when the one-way valve is in a closed position, and the one-way valve may allow the hot gas and/or particles to vent through the one-way valve when the one-way valve is in the open position.

The RESS 24 may include a binder clip 60 (FIG. 6A) attached to each battery cell group of the plurality of battery cell groups 28-1, 28-2 included in each of the at least two battery modules 26-1, 26-2. Each binder clip 60 extends along a length L of each battery cell group within each of the plurality of battery cell groups 28-1, 28-2 and directs the hot gas and/or particles toward the thermal barrier 30-1, 30-2, at the end of each of the at least two battery modules 26-1, 26-2.

The RESS 24 may include a seal 62 (FIG. 6B) disposed between adjacent battery cell groups within each plurality of battery cell groups 28-1, 28-2 included in each of the at least two battery modules. The seal 62 prevents hot gas and/or particles from flowing from a propagated cell group to a non-propagated cell group within each of the at least two battery modules. The seal 62 may include, for example but not limited to, a bulb seal.

According to another aspect of the present disclosure, with reference to FIGS. 1-5, wherein like numerals represent like components, a rechargeable energy storage system (RESS) 24 having thermal runaway propagation mitigation may include a plurality of battery modules 26 (FIG. 1) disposed within the RESS 24. Each of the plurality of battery modules 26 includes a plurality of battery cell groups 28 within each battery module 26.

A thermal barrier 30 is disposed at an end portion 34 of each of the plurality of battery modules 26 and extends along a width W of the end portion 34 of each of the plurality of battery modules 26.

Each thermal barrier 30 includes a plurality of openings 50 including at least one opening 50 aligned with each of the plurality of battery cell groups 28 included in each of the plurality of battery modules 26.

A relief portion 54 is adjacent to each of the plurality of openings 50. The relief portion 54 prevents hot gas and/or particles from venting through the relief portion 54 when the relief portion 54 is in a closed position P₁, and allows hot gas and/or particles to vent through the relief portion 54 when the relief portion 54 is in an open position P2.

The thermal barriers 30 disposed at the end portions 34 of each of the plurality of battery modules 26 form a cross-car thermal barrier system.

Each of the plurality of battery modules 26 is adjacent to another of the plurality of battery modules 26 in a cross-car configuration.

The plurality of battery modules 26 includes a first battery module 26-1 having a first plurality of battery cell groups 28-1, and a second battery module 26-2 having a second plurality of battery cell groups 28-2.

The first plurality of battery cell groups 28-1 includes at least one propagated battery cell. Hot gas and/or particles from the at least one propagated battery cell included in the first plurality of battery cell groups 28-1 vents through the relief portion 54-1 of the thermal barrier 30-1 adjacent to the opening 50-1 in the thermal barrier 30-1 that is aligned with the first plurality of battery cell groups 28-1, via a first gas pathway 58-1 that vents the hot gas and/or particles, from the at least one propagated battery cell included in the first plurality of battery cell groups 28-1, to an outside of the RESS 24.

The second plurality of battery cell groups 28-2 includes at least one propagated battery cell. Hot gas and/or particles from the at least one propagated battery cell included in the second plurality of battery cell groups 28-2 vents through the relief portion 54-2 of the thermal barrier 30-2 adjacent to the opening 50-2 in the thermal barrier 30-2 that is aligned with the second plurality of battery cell groups 28-2, via a second gas pathway 58-2 that vents the hot gas and/or particles, from the at least one propagated battery cell included in the second plurality of battery cell groups 28-2, to the outside of the RESS 24.

The first gas pathway 58-1 and the second gas pathway 58-2 are unaligned with one another.

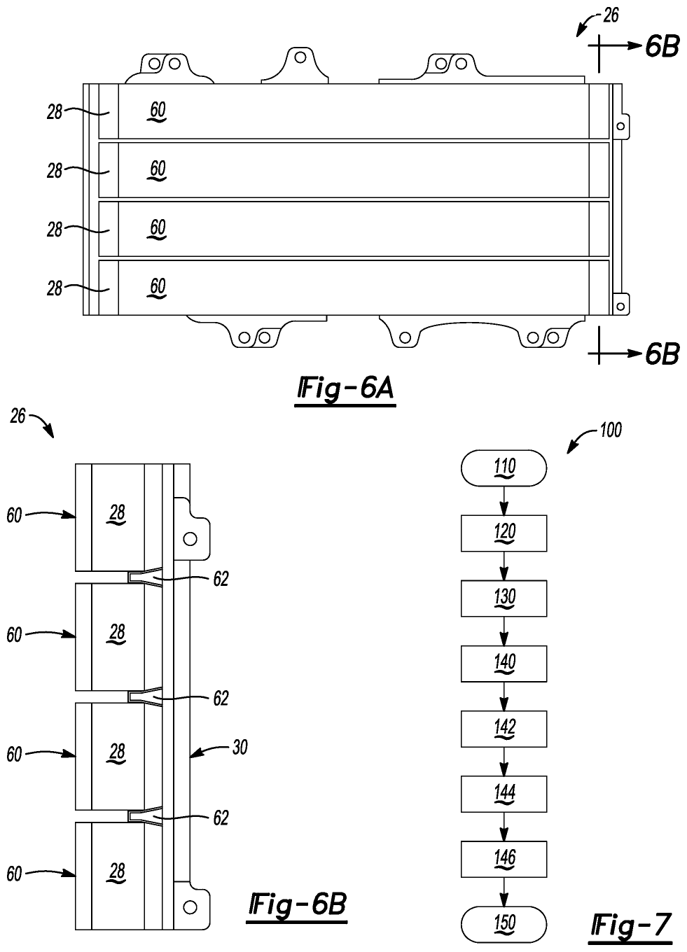

According to another aspect of the present disclosure, a method 100 of thermal runaway propagation mitigation within a rechargeable energy storage system (RESS) 24 of a vehicle 10 is illustrated in FIG. 7, and described below with reference to the structure illustrated in FIGS. 1-5.

The method 100 includes: installing 110 the rechargeable energy storage system (RESS) 24 in the vehicle, the RESS 24 including a first battery module 26-1 and a second battery module 26-2, each of the first battery module 26-1 and the second battery module 26-2 having a plurality of battery cell groups 28-1, 28-2, wherein the first battery module includes a first thermal barrier 30-1 disposed at an end portion of the first battery module 26-1, and the second battery module 26-2 includes a thermal barrier 30-2 disposed at an end portion of the second battery module 26-2, each of the first thermal barrier 30-1 and the second thermal barrier 30-2 extending along a width W of the end portion 34-1, 34-2 of each of the first battery module 26-1 and the second battery module 26-2; generating 120 power for the vehicle 10, via the RESS 24; experiencing 130 a thermal runaway event in one of the first battery module 26-1 and the second battery module 26-2; and directing 140, hot gas and/or particles from the one of the first battery module 26-1 and the second battery module 26-2 that is experiencing the thermal runaway event, i.e., that includes a propagated battery cell group, away from the other of the first battery module 26-1 and the second battery module 26-2 that is not experiencing the thermal runaway event, i.e., that includes no propagated battery cell groups, wherein the hot gas and/or particles are directed away via the thermal barrier 30-1, 30-2 of the one of the first battery module 26-1 and the second battery module 26-2 that is experiencing the thermal runaway event.

Each of the thermal barriers 30-1, 30-2 includes a plurality of openings 50-1, 50-2 including at least one opening aligned with each of the plurality of battery cell groups 28-1, 28-2 and relief portions 54-1, 54-2 adjacent to each of the plurality of openings 50-1, 50-2.

The method 100 of thermal runaway propagation mitigation including: venting 150 hot gas and/or particles from a first propagated cell group of the first battery module 26-1 to an outside of the RESS 24 via a first gas pathway 58-1; and venting 160 hot gas and/or particles from the second propagated cell group of the second battery module 26-2 to the outside of the RESS 24 via a second gas pathway 58-2.

The first thermal barrier 30-1 is adjacent to the second thermal barrier 30-2, and the first gas pathway 58-1 and the second gas pathway 58-2 are unaligned with one another.

Directing 140 the hot gas and/or particles from the propagated battery cell group includes: moving 142 the relief portion 54-1, 54-2 of the thermal barrier 30-1, 30-2 adjacent to the opening 50-1, 50-2 in the thermal barrier 30-1, 30-2 aligned with the propagated battery cell group of the plurality of battery cell groups 28-1, 28-2, to an open position P2; allowing 144 the hot gas and/or particles to vent through the relief portion 54-1, 54-2 of the thermal barrier 30-1, 30-2; and venting 146 the hot gas and/or particles from the propagated battery cell group of the plurality of battery cell groups 28-1, 28-2 through the relief portion 54-1, 54-2 of the thermal barrier 30-1, 30-2 adjacent to the opening 50-1, 50-2 in the thermal barrier 30-1, 30-2 aligned with the propagated battery cell group of the plurality of battery cell groups 28-1, 28-2.

The relief portion 54-1, 54-2 of the thermal barrier 30-1, 30-2 may be moved to the open position P2 by the hot gas from the propagated battery cell group of the plurality of battery cell groups 28-1, 28-2.

Hot gas and/or particles from the propagated battery cell group of the plurality of cell groups 28-1, 28-2 vents through the relief portion 54-1, 54-2 of the thermal barrier 30-1, 30-2 via gas pathways 58-1, 58-2. The hot gas and/or particles are vented to an outside of the RESS 24.

When the relief portion 54-1, 54-2 of the thermal barrier 30-1, 30-2 adjacent to the opening 50-1, 50-2 in the thermal barrier 30-1, 30-2 aligned with the propagated battery cell group of the plurality of battery cell groups 28-1, 28-2 is moved to the open position P2, the relief portion 54-1, 54-2 of the thermal barrier 30-1, 30-2 adjacent to the opening 50-1, 50-2 in the thermal barrier 30-1, 30-2 aligned with the non-propagated battery cell groups of the plurality of battery cell groups 28-1, 28-2 may remain in a closed position P₁.

Venting the hot gas and/or particles from the propagated battery cell group of the plurality of cell groups 28-1, 28-2 may prevent a temperature T of the non-propagated battery cell group from exceeding a thermal runaway propagation threshold temperature Tₘₐₓ.

Therefore, by including a thermal barrier disposed at an end portion of each battery module within a rechargeable energy storage system (RESS), thermal runaway propagation mitigation may be provided, which may protect battery modules that are not experiencing a thermal runaway event, but which are adjacent to a battery module experiencing a thermal runaway event, from propagation of the thermal runaway by venting hot gas and/or particles from the battery module experiencing the thermal runaway event, and directing the hot gas and/or particles from the battery module experiencing the thermal runaway event, to an outside of the RESS.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A rechargeable energy storage system (RESS) for a vehicle having thermal runaway propagation mitigation, the RESS comprising:
at least two battery modules disposed within the RESS wherein each of the at least two battery modules includes:
a plurality of battery cell groups; and
a thermal barrier disposed at an end portion of each of the at least two battery modules, the thermal barrier extending along a width of the end portion of each of the at least two battery modules, wherein the thermal barrier includes:
a plurality of openings including at least one opening aligned with each of the plurality of battery cell groups of each of the at least two battery modules; and
a relief portion adjacent to each of the plurality of openings, wherein the relief portion prevents hot gas and/or particles from venting through the opening adjacent to the relief portion when the relief portion is in a closed position, and wherein the relief portion allows the hot gas and/or particles to vent through the opening adjacent to the relief portion when the relief portion is in an open position.

2. The RESS as recited in claim 1, wherein the plurality of battery cell groups included in one of the at least two battery modules includes at least one propagated battery cell group, and the plurality of battery cell groups included in another of the at least two battery modules includes no propagated battery cell groups.

3. The RESS as recited in claim 2, wherein the thermal barrier directs hot gas and/or particles from the one of the at least two battery modules including the at least one propagated battery cell group away from the other of the at least two battery modules including no propagated battery cell groups, and/or a high voltage connection.

4. The RESS as recited in claim 2, wherein hot gas from the at least one propagated battery cell group moves the relief portion of the thermal barrier adjacent to the opening aligned with the at least one propagated battery cell group, to the open position.

5. The RESS as recited in claim 4, wherein the hot gas and/or particles from the at least one propagated battery cell group vents through the opening adjacent to the relief portion of the thermal barrier, via gas pathways that vent the hot gas and/or particles to an outside of the RESS.

6. The RESS as recited in claim 1, wherein the plurality of battery cell groups included in one of the at least two battery modules includes at least one battery cell group having at least one propagated battery cell, and at least one battery cell group having no propagated battery cells,
wherein the relief portion of the thermal barrier, adjacent to the opening aligned with the at least one battery cell group including the at least one propagated battery cell, is in an open position, and the relief portion of the thermal barrier, adjacent to the opening aligned with the at least one battery cell group having no propagated cells, is in a closed position.

7. The RESS as recited in claim 1, wherein the thermal barrier prevents a temperature of at least one of the at least two battery modules from exceeding a thermal runaway propagation threshold temperature.

8. The RESS as recited in claim 1, wherein the relief portion of the thermal barrier includes a one-way valve, and the one-way valve prevents the hot gas and/or particles from venting through the one-way valve when the one-way valve is in the closed position, and the one-way valve allows the hot gas and/or particles to vent through the one-way valve when the one-way valve is in the open position.

9. The RESS as recited in claim 1, wherein the relief portion of the thermal barrier includes a break-away portion.

10. The RESS as recited in claim 1, including a binder clip attached to each battery cell group of the plurality of battery cell groups included in each of the at least two battery modules, wherein each binder clip extends along a length of each battery cell group and directs the hot gas and/or particles toward the thermal barrier at the end of each of the at least two battery modules.

11. The RESS as recited in claim 1, including a seal disposed between adjacent battery cell groups within the plurality of battery cell groups included in each of the at least two battery modules, wherein the seal prevents the hot gas and/or particles from flowing from a propagated cell group to a non-propagated cell group within each of the at least two battery modules.

12. A rechargeable energy storage system (RESS) having thermal runaway propagation mitigation, the RESS comprising:
a plurality of battery modules disposed within the RESS, each of the plurality of battery modules including a plurality of battery cell groups; and
a thermal barrier disposed at an end portion of each of the plurality of battery modules, each thermal barrier extending along a width of the end portion of each of the plurality of battery modules, wherein each thermal barrier includes:
a plurality of openings including at least one opening aligned with each of the plurality of battery cell groups included in each of the plurality of battery modules; and
a relief portion adjacent to each of the plurality of openings, wherein the relief portion prevents hot gas and/or particles from venting through the opening adjacent to the relief portion when the relief portion is in a closed position, and wherein the relief portion allows hot gas and/or particles to vent through the opening adjacent to the relief portion when the relief portion is in an open position; and
wherein the thermal barriers disposed at the end portions of each of the plurality of battery modules form a cross-car thermal barrier system, and
wherein each of the plurality of battery modules is adjacent to another of the plurality of battery modules in a cross-car configuration.

13. The RESS as recited in claim 12, wherein the plurality of battery modules includes:
a first battery module having a first plurality of battery cell groups; and
a second battery module having a second plurality of battery cell groups,
wherein the first plurality of battery cell groups includes at least one propagated battery cell, and the hot gas and/or particles from the at least one propagated battery cell included in the first plurality of battery cell groups, vents through the opening adjacent to the relief portion of the thermal barrier, and aligned with the first plurality of battery cell groups, via a first gas pathway that vents the hot gas and/or particles, from the at least one propagated battery cell included in the first plurality of battery cell groups, to an outside of the RESS,
wherein the second plurality of battery cell groups includes at least one propagated battery cell, and the hot gas and/or particles from the at least one propagated battery cell included in the second plurality of battery cell groups, vents through the opening adjacent to the relief portion of the thermal barrier, and aligned with the second plurality of battery cell groups, via a second gas pathway that vents the hot gas and/or particles, from the at least one propagated battery cell included in the second plurality of battery cell groups, to the outside of the RESS, and
wherein the first gas pathway and the second gas pathway are unaligned with one another.

14. A method of thermal runaway propagation mitigation within a rechargeable energy storage system (RESS) of a vehicle comprising:
installing the RESS in the vehicle, the RESS including at a first battery module and a second battery module, each of the first battery module and the second battery module having a plurality of battery cell groups, wherein the first battery module includes a first thermal barrier disposed at an end portion of the first battery module, and the second battery module includes a second thermal barrier disposed at an end portion of the second battery module, each of the first thermal barrier and the second thermal barrier extending along a width of the end portion of each of the first battery module and the second battery module, and each thermal barrier including:
a plurality of openings including at least one opening aligned with each of the plurality of battery cell groups; and
a relief portion adjacent to each of the plurality of openings; and
generating power for the vehicle, via the RESS; and
directing, hot gas and/or particles from one of the first battery module and the second battery module that includes a propagated battery cell group away from the other of the first battery module and the second battery module that includes no propagated battery cell groups, wherein the hot gas and/or particles are directed away via the thermal barrier of the one of the first battery module and the second battery module that includes no propagated battery cell groups.

15. The method of thermal runaway propagation mitigation as recited in claim 14, including:
venting hot gas and/or particles from the first battery module having a first propagated cell group to an outside of the RESS via a first gas pathway, and venting hot gas and/or particles from the second battery module having a second propagated cell group to the outside of the RESS via a second gas pathway, wherein the first thermal barrier is adjacent cross-car to the second thermal barrier, and the first gas pathway and the second gas pathway are unaligned with one another.

16. The method of thermal runaway propagation mitigation as recited in claim 14, wherein directing the hot gas and/or particles from the one of the first battery module and the second battery modules including the propagated battery cell group includes:
moving the relief portion of the thermal barrier adjacent to the opening in the thermal barrier aligned with the propagated battery cell group, to an open position;
allowing the hot gas and/or particles to vent through the opening adjacent to the relief portion of the thermal barrier; and
venting the hot gas and/or particles from the propagated battery cell group through the opening adjacent to the relief portion of the thermal barrier, and aligned with the propagated battery cell group.

17. The method of thermal runaway propagation mitigation as recited in claim 16, wherein the relief portion of the thermal barrier is moved to the open position by the hot gas from the propagated battery cell group.

18. The method of thermal runaway propagation mitigation as recited in claim 17, wherein the hot gas and/or particles from the propagated battery cell group vents through the opening adjacent to the relief portion of the thermal barrier via gas pathways that vent the hot gas and/or particles to an outside of the RESS.

19. The method of thermal runaway propagation mitigation as recited in claim 18, wherein when the relief portion of the thermal barrier adjacent to the opening in the thermal barrier aligned with the propagated battery cell group is moved to the open position, the relief portion of the thermal barrier adjacent to the opening in the thermal barrier aligned with the non-propagated battery cell group remains in a closed position.

20. The method of thermal runaway propagation mitigation as recited in claim 19, wherein venting the hot gas and/or particles from the propagated battery cell group a temperature of the non-propagated battery cell group from exceeding a thermal runaway propagation threshold temperature.
